(19) United States
(12) Patent Application Publication
(10) Pub. No.: US 2005/0018100 A1
(43) Pub. Date: Jan. 27, 2005

(54) Method for repairing LCD light spots

(76) Inventors: Shih-Wei Chen, Yijhu Township (TW); Kuan-Yi Hsu, Taoyuan City (TW); Kuan-Ying Lin, Jhubei City (TW); Wei-Lung Liao, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/850,271

(22) Filed: May 20, 2004

(30) Foreign Application Priority Data
Jul. 25, 2003 (TW) 92120333

(51) Int. Cl. G02F 1/1333

(52) U.S. Cl. 349/54

(57) ABSTRACT

A method for repairing light spots in an LCD. An LCD is provided, comprising an array plate, a bottom polarized plate thereunder, a color filter plate over the array plate and a top polarized plate over the color filter plate. The LCD is inspected to locate light spots, and shields are formed on the top polarized plate to cover the light spots, thereby repairing the light spots.

### BACKGROUND OF THE INVENTION

1. Field of the Invention

The present invention relates to a method for fabricating a liquid crystal display, and more particularly, to a method for repairing light spots therein.

2. Description of the Related Art

Liquid crystal displays have become widely used, with a working principle based on alignment condition of liquid crystal molecules changing by application of an electrical field to change the path of light passing therethrough. One LCD type is passive matrix and the other active matrix. Color of each pixel is determined by current of an end transistor in the row and the start transistor in the column. Advantages of passive matrix LCD are low cost and small size, however, slow scanning speed and small viewing angle are drawbacks. In active matrix LCD, each pixel is controlled by a transistor, and scanning is fast.

The active matrix LCD includes more than million transistors and display units, each display unit consisting of three sub display units(R, G, B).

Dot defects are formed during process of the active matrix LCD, creating light or dark defects. LCD units having fewer than five dot defects are considered as A class, however, because light defects, light defects are more noticeable to users, they are repaired into dark defects.

There are three major causes of light spot defects. As shown in the point C of FIG. 1, the first cause is the broken circuit between the TFT 12 and the pixel electrode 10. The second cause is the broken channel D of the TFT 12, such that the TFT cannot be operated. The third cause is the short circuit E between the pixel electrode 10 and the signal line SL, as shown in the point E of FIG. 1

Light spots resulting from the three situations described can be repaired by cutting the line between pixel electrode 10 and the signal line SL. The light spot in the first and second cases can be repaired by connecting the line between pixel electrode 10 and the gate line GL, however, both present low repair yield.

As well, laser repair presents limitations, such as reduced voltage of the gate line. Light spot defects from scratching of the polarized plate, scratches of film on glass or defects on the Black Matrix BM of the color filter substrate cannot be repaired by laser repair, wherein defects on BM of the color filter substrate may be generated during process of the color filter, ESD punching through the film or scratching the color filter substrate surface. As well, defects in BM may also be generated during LCD process.

Japanese publication numbers 5-2160 and 4-301615, and U.S. Pat. Nos. 5,546,206 and 6,097,462 disclose methods of repairing light spot defects by laser, however, the low repair yield problem remains unsolved.

### SUMMARY OF THE INVENTION

An object of the present invention is to provide a method of repairing light spot defect not repairable by laser, such that repair yield is increased.

To achieve the above objects, the present invention provides a method for repairing light spots in an LCD. A display, comprising a light source, a bottom polarized plate over the light source, an array substrate over the bottom polarized plate, a color filter substrate over the array substrate and a top polarized plate over the color filter substrate is provided. The LCD is inspected to locate light spots. A plurality of shields are formed to block light paths from the light source through the light spots.

It is to be understood that both the foregoing general description and the following detailed description are exemplary and explanatory only and are not restrictive of the invention, as claimed.

### BRIEF DESCRIPTION OF THE DRAWINGS

The present invention can be more fully understood by reading the subsequent detailed description in conjunction with the examples and references made to the accompanying drawings, wherein:

FIG. 1 is a plane view of an array showing a pixel containing light spot defects.

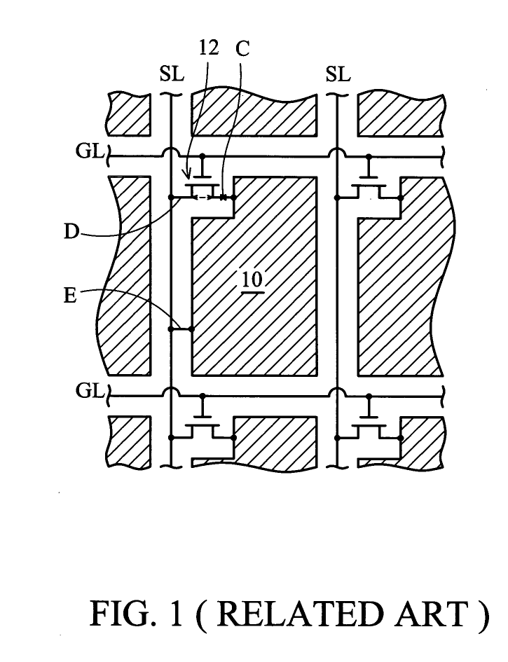

FIG. 2 is a cross section of the LCD.

FIG. 3 is a circuit diagram of the LCD.

FIG. 4 is a plane view of the array.

FIG. 5 is a flowchart of the light spot repair of the invention.

### DETAILED DESCRIPTION OF THE INVENTION

The present invention will be described in detail with reference to the accompany drawings.

### FIRST EMBODIMENT

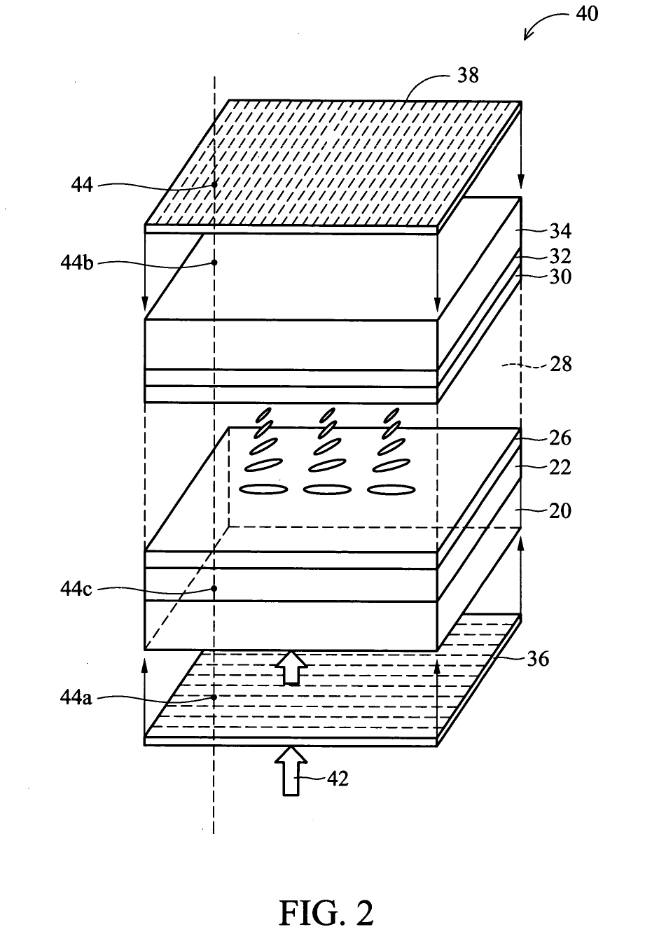

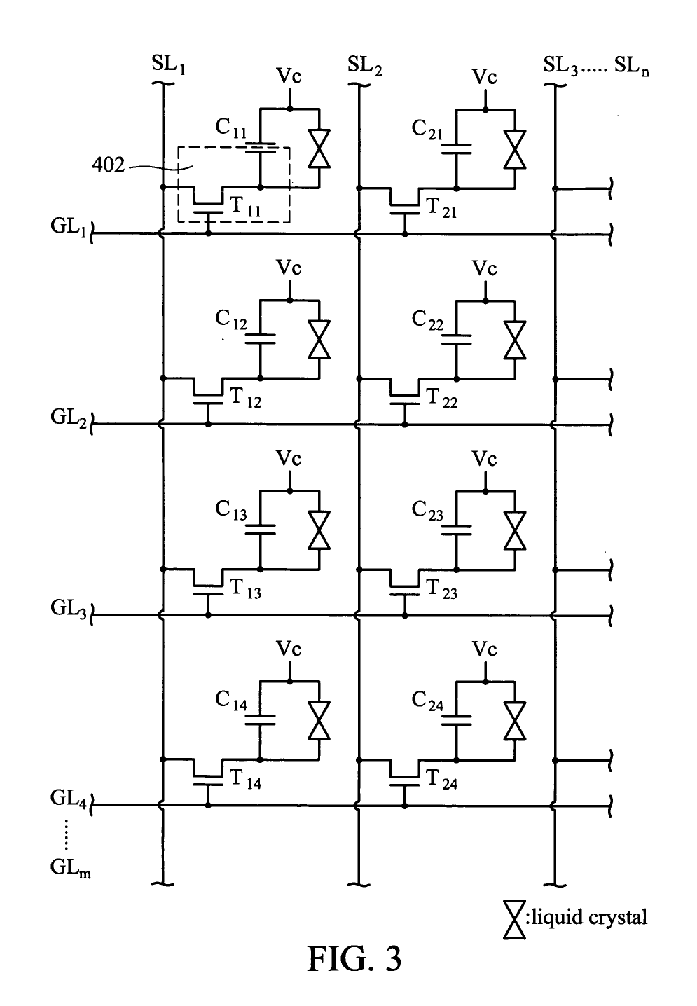

In FIG. 2, a liquid crystal display 40 includes an array substrate 20, an opposite color filter substrate 34, a liquid crystal layer 28 therein, a top polarized plate 38 on the color filter substrate 34 and the bottom polarized plate 36 below the array substrate 20. As shown in FIG. 3, signal lines (SL1, SL2 . . . SLn) and gate lines (GL1, GL2 . . . GLm) are formed on the substrate arranged in a matrix. A pixel is defined by neighboring gate lines and signal lines. A TFT device is disposed on each pixel, each (T11, T12, T21, . . . , Tnm) connected respectively to a pixel electrode 402. The pixel electrode comprises a patterned transparent conductive film, such as an ITO film (Indium tin oxide film).

As shown in FIG. 2, an alignment film 26 is formed on the substrate in one direction. The array substrate 20 is covered with a common electrode 32, a patterned transparent and conductive film, such as ITO. As well, an alignment film 30 is formed on the common electrode 32, in a direction perpendicular to that of the alignment film 26. Liquid crystal 28 is injected into the gap between the alignment film 30 on the color filter substrate 34 and the alignment film 26 on the array substrate 20. A top polarized plate 38 and a bottom polarized plate 36 are respectively disposed outside the color filter substrate 34 and array substrate 20. Light absorption axes of top polarized plate 38 and bottom polarized plate 36 are perpendicular.

The LCD is illuminated with a light 42 to locate light spots therein, such as at the broken circuits between TFT 12 and pixel electrode 10, broken circuits of the tunnel in TFT 12, particles on color filter substrate 34 or array substrate 20, scratches on polarized plates 36 and 38, or on the BM (Black Matrix).

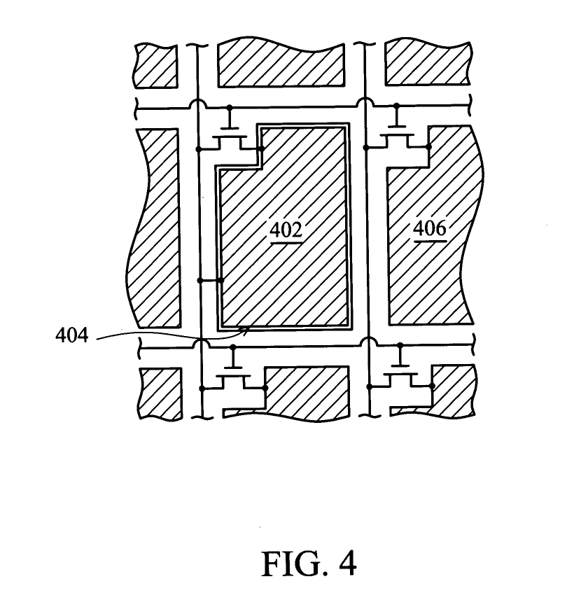

Referring to FIG. 2, a shield 44 is formed on the top polarized plate 38 according to the positions detected, repairing the light spots. The shield 44 may be formed by opaque organic or inorganic coating, such as ink or dye. In FIG. 4, the shield must be larger than the square with the short side 404 of the pixel 402, but a maximum of half the area of the neighboring pixel 406, and preferably one third of the area of the neighboring pixel 406 remains uncovered.

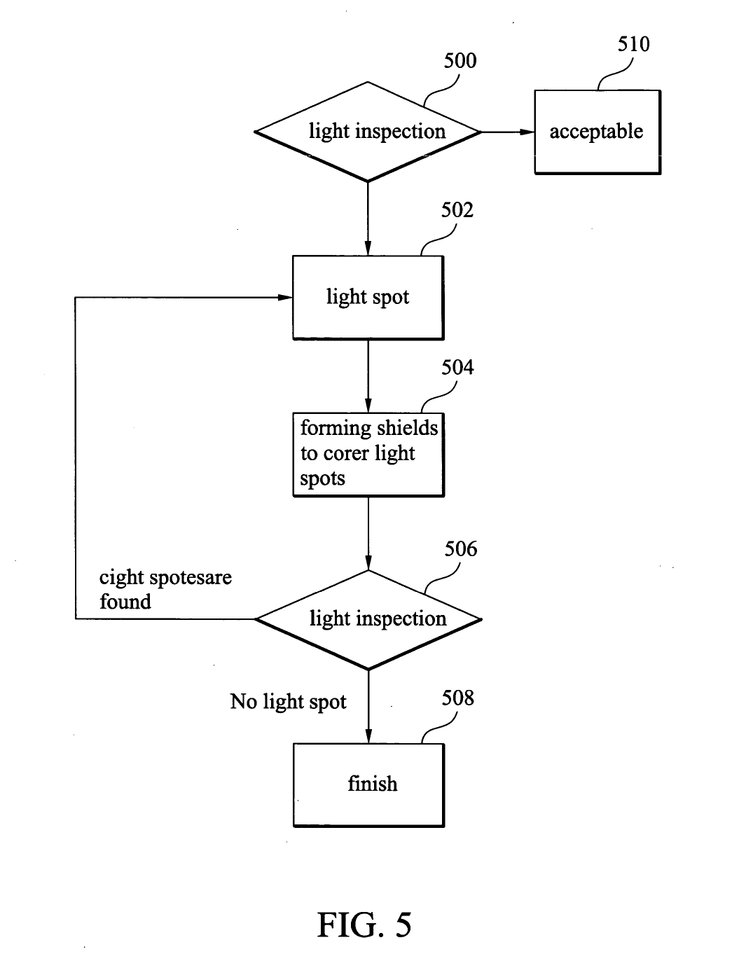

The shield 44 is removable by solvent, such as IPA, to be reworkable. Referring to FIG. 5, the LCD is inspected by the light inspecting system (S500), and considered acceptable, if no light spots are found (S510), or unacceptable (S502). The LCD is repaired by forming shields to cover light spots (S504) and is then rechecked (S506). Repair is complete (S508) if no light spots are found after repair, however, if light spots still exist, repeat repair is required (S502).

As shown in FIG. 2, light 42 can pass the polarized plate 36, being polarized in one direction if the common electrode 32 and the pixel electrode 22 are powered off. Light 42 passes TFT substrate 20, the pixel electrode 22, and the liquid crystal layer 28, with the direction of light 42 being polarized 90° by the effect of the liquid crystal molecule. Because light 42, after polarization, is the same direction as plate 38, light can pass the LCD, resulting in display.

### SECOND EMBODIMENT

In FIG. 2, LCD 40 includes an array substrate 20, a color filter substrate 34, a liquid crystal layer 28 therein, a top polarized plate 38 on the color filter substrate and a bottom polarized plate 36 below the array substrate 20.

The LCD is illuminated with light 42 to locate light spots therein, such as at broken circuits between TFT 12 and pixel electrode 10, broken circuits in the tunnel in TFT 12, particles on the color filter substrate 34 or the array substrate 20, or scratches in polarized plate 36 or 38 in the BM (Black Matrix).

Referring to FIG. 2, a shield 44a is formed on the bottom of the bottom polarized plate 36 according to the positions detected, thereby repairing the light spots. The shield 44 may be formed by opaque organic or inorganic coating, such as ink or dye. As shown in FIG. 4, the shield must be larger than the square with the short side 404 of the pixel 402, however, a maximum of half the area of the neighboring pixel 406, and preferably one third of the area of the neighboring pixel 406, remains uncovered.

### THIRD EMBODIMENT

In FIG. 2, the liquid crystal display 40 includes an array substrate 20, a color filter substrate 34, a liquid crystal layer 28 therein, a top polarized plate 38 on the color filter substrate 34, and a bottom polarized plate 36 below the array substrate 20.

The LCD is illuminated with a light 42 to locate light spots therein, such as at broken circuits between TFT 12 and pixel electrode 10, at broken circuits in the tunnel in TFT 12, particles on the color filter substrate 34 or the array substrate 20, or scratches in polarized plate 36 or 38, or in the BM (Black Matrix).

Referring to FIG. 2, a shield 44b is formed on the color filter substrate 34 according to the positions detected, thereby repairing the light spots. The shield 44 may be formed by opaque organic or inorganic coating, such as ink or dye. As shown in FIG. 4, the shield must be larger than the square with the short side 404 of the pixel 402, however, a maximum of half the area of the neighboring pixel 406, and preferably one third of the area of the neighboring pixel 406, remains uncovered.

### FOURTH EMBODIMENT

In FIG. 2, the liquid crystal display 40 includes an array substrate 20, a color filter substrate 34, a liquid crystal layer 28 therein, a top polarized plate 38 on the color filter substrate 34, and a bottom polarized plate 36 below the array substrate 20.

The LCD is illuminated with a light 42 to locate positions of light spots therein, such as at broken circuits between TFT 12 and pixel electrode 10, broken circuits in the tunnel in TFT 12, particles on the color filter substrate 34 or the array substrate 20, or scratches in polarized plate 36 or 38 in the BM (Black Matrix).

Referring to FIG. 2, a shield 44c is formed on the bottom of the array substrate 20 in located positions, covering the light spot, thereby repairing the light spots. The shield 44 may be formed by opaque organic or inorganic coating, such as ink or dye. As shown in FIG. 4, the shield must be larger than the square with the short side 404 of the pixel 402, however, a maximum of half the area of the neighboring pixel 406, and preferably one third of the area of the neighboring pixel 406 remains uncovered.

The advantage of the present invention is that particles or scratches irreparable by laser can be repaired by forming shields on the top polarized plate, the bottom polarized plate, the color filter substrate, or the array substrate.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A method for repairing light spots in an LCD, comprising:
providing a display, comprising a light source, a bottom polarized plate over the light source, an array substrate over the bottom polarized plate, a color filter substrate over the array substrate and a top polarized plate over the color filter substrate;
inspecting the LCD to locate light spots; and
forming shields to block light paths from the light source through the light spots.

2. The method according to claim 1, wherein the array substrate and the color filter substrate are glass.

3. The method according to claim 1, wherein the shields are formed on the bottom polarized plate.

4. The method according to claim 1, wherein the shields are formed on the array substrate.

5. The method according to claim 1, wherein the shields are formed on the color filter substrate.

6. The method according to claim 4, wherein the shields are formed on the top polarized plate.

7. The method according to claim 1, wherein the shields are ink or dye.

8. The method according to claim 1, wherein the array substrate comprises a plurality of pixels, the shield is larger than the square with the short side of each pixel, and half the area of the neighboring pixel is not covered.

9. The method according to claim 8, wherein one third of the area of the neighboring pixel is not covered.

10. A method for repairing light spots in an LCD, comprising:
providing a display substrate, comprising an array substrate, a color filter substrate over the array substrate and a top polarized plate over the color filter substrate;
inspecting the LCD to locate light spots;
locating positions of the light spots; and
forming shields on the bottom polarized plate, the array substrate, the top polarized plate or the color filter substrate to repair the light spots.

11. The method according to claim 10, wherein the array substrate and the color filter substrate are glass.

12. The method according to claim 10, wherein the shields are ink or dye.

13. The method according to claim 10, wherein the array substrate comprises a plurality of pixels, the shield is larger than the square with the short side of each pixel, and half the area of the neighboring pixel is not covered.

14. The method according to claim 13, wherein one third of the area of the neighboring pixel is not covered.
